(19) United States
(12) Patent Application Publication
(10) Pub. No.: US 2024/0112120 A1
(43) Pub. Date: Apr. 4, 2024

(54) QUANTIFYING HUMAN SENTIMENT TO DETERMINE A SENTIMENT SCORE REFLECTIVE OF THE HEALTH OF A PROJECT

(71) Applicant: Insight Direct USA, Inc., Tempe, AZ (US)

(72) Inventors: Benjamin Lee Burke, Waxhaw, NC (US); Jason Bradford Laws, Matthews, NC (US); Delijah S. Williams, Woodstock, GA (US); Michael McKernan, Charlotte, NC (US)

(21) Appl. No.: 17/958,807

(22) Filed: Oct. 3, 2022

(51) Int. Cl. G06Q 10/06

(52) U.S. Cl. CPC G06Q 10/06393

(57) ABSTRACT

A process of determining a sentiment score from a response from at least one individual regarding a status of a project that includes receiving a first numerical rating regarding the status of the project from a first individual of the at least one individual, receiving a first textual description regarding the heath of the project from the first individual, determining a first textual score dependent upon the first textual description with the first textual score being a numerical representation of the first textual description, and aggregating the first numerical rating and the first textual score to determine a first sentiment score reflective of the status of the project by the first individual.

### BACKGROUND

This disclosure relates generally to project management and, more specifically, to quantifying individual subjective responses to an inquiry regarding the status/health of a project into an objective sentiment score.

The status of each individual project in their practice's portfolio is very important to managing principals, as customer satisfaction and profitability are key performance indicators to executive leadership. Currently, managing principals depend solely on their project managers to provide the status of these projects via standardized reports and 1:1 status updates. Such an approach is time consuming and may not yield an assessment that is particularly useful as an individual may not have the experience to see potential issues, or worse, may not be entirely forthright with a managing principal if the assessment is negative. A more remote work force may require a higher need for in-depth check-ins to determine how the project is progressing.

### SUMMARY

A process of determining a sentiment score from a response from at least one individual regarding a status/health of a project that includes receiving a first numerical rating regarding the status of the project from a first individual of the at least one individual, receiving a first textual description regarding the heath of the project from the first individual, determining a first textual score dependent upon the first textual description with the first textual score being a numerical representation of the first textual description, and aggregating the first numerical rating and the first textual score to determine a first sentiment score reflective of the status of the project by the first individual.

A system for determining a sentiment score from a response from at least one individual regarding a status/health of a project can include a communication device configured to send a project inquiry to the at least one individual and receive an inquiry response from the at least one individual with the inquiry response including at least one numerical rating and at least one textual description regarding the status of the project, storage media configured to store the project inquiry and the inquiry response, and a computer processor configured to determine at least one textual score dependent upon the at least one textual description and at least one sentiment score for each of the at least one individual dependent upon the at least one numerical rating and at least one textual score.

### BRIEF DESCRIPTION OF THE DRAWINGS

FIG. 1 is schematic showing the solicitation and collection of sentiment project information.

FIG. 2 is schematic showing exemplary information of multiple projects and individual profiles.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

Systems and methods are disclosed herein to determine a sentiment score from responses from each individual team member working to complete a project—not just the project manager. Each response from the individuals can include two parts: a numerical rating and a textual description regarding the status/health of the project from each individual (e.g., an answer to the question: “how is the project going?”). The textual description of each response is analyzed to determine a textual score that is a numerical representation of the textual description (e.g., a sentiment analysis that assigns each word in the description as being positive, negative, or neutral; a text analysis that assigns a value to each word in the description; a phrase analysis to determine the positivity or negativity of phrases in the description; etc.). Each textual score can then be aggregated with each numerical rating to determine each individual's sentiment score, which represents/reflects a quantitative value of the individual's assessment of the project.

The sentiment score from each individual can be reviewed by the managing principal to determine the individual's assessment of the status of the project without having to spend large amounts of time meeting with the individual. Additionally, the sentiment score can be determined for each individual that submits a response regarding the project, so an average sentiment score reflecting how all of the individuals working on the project feel the project is going can be determined and reviewed by the managing principal to get a quick assessment. The sentiment score of different work groups associated with the project can also be determined by averaging the sentiment scores of the individuals within that work group. Further, the responses can be formed/submitted by each individual periodically (such as weekly), and the sentiment score can be compared to previous sentiment scores to track whether individual, group, and/or collective assessments of project status/health are increasing or decreasing. The managing principal can quickly review the sentiment scores and determine whether the individuals think the project is going well or poorly even before budgetary and schedule analyses are performed. Additionally, other information can be derived from the sentiment scores, such as whether an individual, work group, or entire team is falling behind, getting burnt out, etc. This allows the managing principal to prioritize their time to the projects and/or personnel that need their attention most, instead of taking a “one size fits all” approach to management.

The system for determining the sentiment scores from responses from individuals can include a communication device configured to send a project inquiry to the individuals working on the project and receive inquiry responses from the individuals. As mentioned above, the inquiry responses can include numerical ratings as well as textual descriptions regarding the status of the project. The system can further include storage media configured to store the project inquiries and the inquiry responses, and a computer processor configured to determine textual scores dependent upon the textual descriptions from the individuals and determine the sentiment scores from each of the numerical ratings and textual scores. The system can also include a dashboard configured to display one or all of the numerical ratings, the textual descriptions, the textual score, and/or the sentiment scores. The system can also determine averages of any of the numerical ratings, the textual scores, and the sentiment scores for all individuals working on the project or any groups/teams working on the project. Further, the communication device can periodically (such as weekly) send out inquiries and receive responses so that the sentiment scores can be determined and tracked periodically and compared to previous sentiment scores for that project to see any trends.

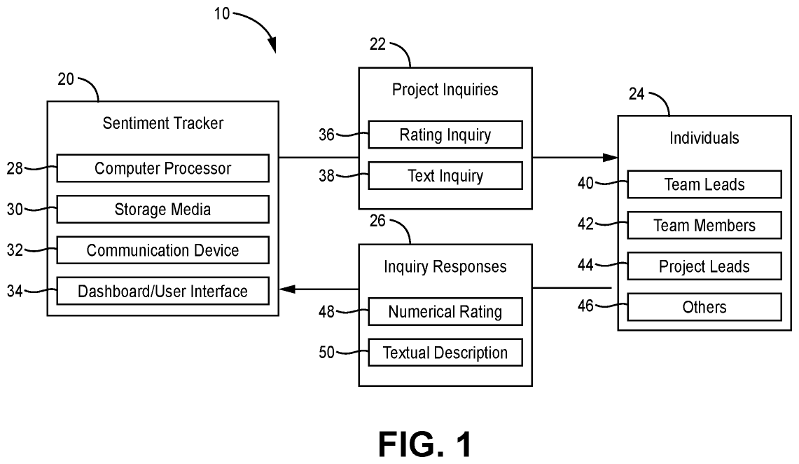

FIG. 1 is a schematic showing system 10 for the solicitation and collection of sentiment project information. System 10 includes sentiment tracker 20, which sends project inquiries 22 to individuals 24 and receives inquiry responses 26 from individuals 24. Sentiment tracker 20 can include computer processor 28, storage media 30, communication device 32, and dashboard/user interface 34. Project inquires 22 can each include rating inquiry 36 and text inquiry 38. Individuals 24 can include team leads 40, team members 42, project leads 44, and/or others 46. Inquiry responses 26 can include numerical rating 48 and textual description 50.

System 10 can include other components not expressly disclosed herein that are suitable for performing the functions of system 10 and associated methods. For example, system 10 can include additional computer processors, user interfaces, storage media, etc. for sending, receiving, and storing information electronically.

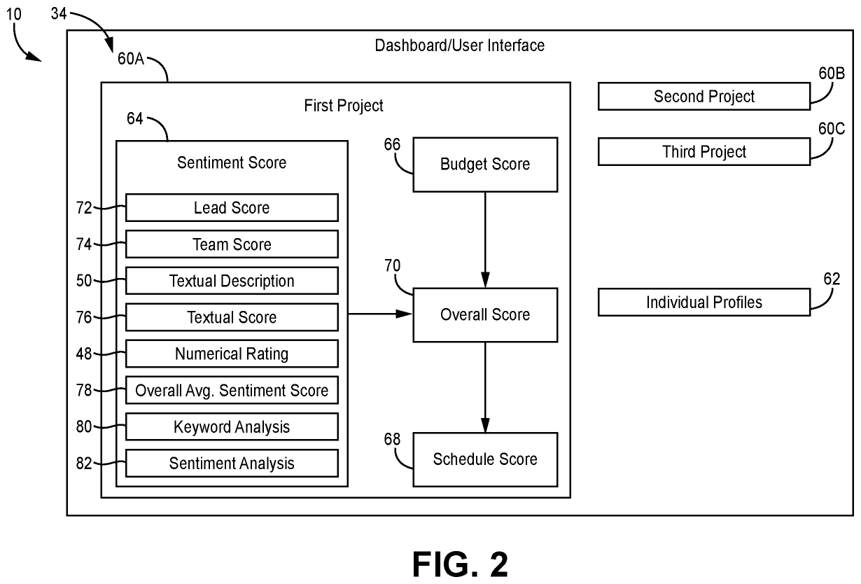

Sentiment tracker 20 can be a computer hardware and/or software system configured to send and receive information as well as store, analyze, and display that information and other information derived from sources distinct from sentiment tracker 20. For example, sentiment tracker 20 can send project inquiries 22 to one or multiple individuals 24 and receive inquiry responses 26 from the one or multiple individuals 24. Sentiment tracker 20 can display the inquiry responses 26, information determined from inquiry responses 26 (such as the sentiment scores), and/or other information (such as a budget score, schedule score, and/or total score) as is described with regards to FIG. 2. All components of system 10 can be incorporated into one all-encompassing component for collecting information from individuals 24 regarding the status of a project and other information about the project, analyzing that information, and displaying the information and any results derived from that information. Sentiment tracker 20 can include any hardware and/or software for performing the functions described herein, and the components of sentiment tracker 20 can be designed/organized in any configuration to perform the functions described herein.

Sentiment tracker 20 can include or function in association with one or multiple computer/data processors 28. In general, the computer/data processors 28 can include any or more than one of a processor, a microprocessor, a controller, a digital signal processor (DSP), an application specific integrated circuit (ASIC), a field-programmable gate array (FPGA), or other equivalent discrete or integrated logic circuitry. Computer processor 28 can perform instructions stored within storage media 30 (or located elsewhere) to formulate/prepare project inquiries 22 for being transmitted/sent by communication device 32. Additionally, computer processor 28 can accept inquiry responses 26 either received from individuals 24 or transmitted/transferred to computer processor 28 from communication device 32, which can be configured to receive any inquiry responses 26. Computer processor 28 can perform other computing processes for other components of sentiment tracker 20, such as performing instructions for the display/functionality of dashboard/user interface 34.

Sentiment tracker 20 can also include or function in association with machine-readable storage media 30 (also referred to herein as storage media 30). In some examples, a machine-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage media 30 can be entirely or in part a temporary memory, meaning that a primary purpose storage media 30 is not long-term storage. Storage media 30, in some examples, is described as volatile memory, meaning that the memory, does not maintain stored contents when power to system 10 (or the component(s) where storage media 30 are located) is turned off. Examples of volatile memories can include random access memories (RAM), dynamic random-access memories (DRAM), static random-access memories (SRAM), and other forms of volatile memories. In some examples, storage media 30 can also include one or more machine-readable storage media 30. Storage media 30 can be configured to store larger amounts of information than volatile memory. Storage media 30 can further be configured for long-term storage of information. In some examples, storage media 30 include non-volatile storage elements. Examples of such non-volatile storage elements can include magnetic hard discs, optical discs, flash memories and other forms of solid-state memory, or forms of electrically programmable memories (EPROM) or electrically erasable and programmable (EEPROM) memories. Generally, storage media 30 is machine-readable data storage capable of housing stored data from a stored data archive. Storage media 30 can be configured to handle any digital/electronic storage needs for system 10, such as project inquiries 22, inquiry responses 26, anything necessary for the use of dashboard/user interface 34, or anything else.

Communication device 32 enables wired or wireless communication between sentiment tracker 20 and individuals 24, such as to send project inquiries 22 to individuals 24 and receive inquiry responses 26 from individuals 24. Communication device 32 can be in communication with the other components of sentiment tracker 20 to receive information that is to be sent out to individuals 24 and other systems. Additionally, communication device 32 can receive other information from other sources, such as receiving information regarding the budget and schedule of a project, and can transmit that information to the other components of sentiment tracker 20. Communication device 32 can be configured to use any common wired or wireless communication.

Dashboard/user interface 34 can be configured to allow a user, such as a managing principal, to view and manipulate information regarding inquiry responses 26 and the project to which the inquiry responses pertain. Dashboard/user interface 34 can include a display device for displaying the information and for allowing manipulation of the information by a user. Dashboard/user interface 34 can include multiple different views that each can be configured to the preferences of a user to display a variety of different information/data regarding multiple projects and/or multiple individuals 24 working of those projects. As with the other components of sentiment tracker 20 (and system 10 generally), dashboard/user interface 34 can be located on multiple devices (e.g., computers) and/or accessible from multiple devices so that multiple users can view and/or manipulate the information from inquiry responses 26 (and other information from the project).

Sentiment tracker 20 sends project inquiries 22 to individuals 24. Project inquiries 22 can each take a variety of forms for eliciting responses from individual 24. For example, project inquiries 22 can be contained in an email and elicit a response from individuals 24. In another example, individuals 24 can be directed by a link or another address to a website or other portal that allows for individuals 24 to enter inquiry responses 26 (and the website can be configured to automatically send those inquiry responses 26 to sentiment tracker 20). Project inquiries 22 can have any configuration for eliciting a response from individuals 24 regarding the status of a project. In one example, each project inquiry 22 includes two questions/solicitations: the first is rating inquiry 36, which requests that each individual 24 rate the status of the project as being either a 1 (poor), 2 (fair), or 3 (good). These numerical ratings can also be a red (poor), yellow (fair), or green (good). The second question can be text inquiry 38, which asks each individual 24 to answer the following question: “how do you feel the project is going?”. Text inquiry 38 is intended to elicit a textual description as a response, with the textual description being further analyzed by sentiment tracker 20.

Individuals 24 are any persons associated with the project that is being analyzed/evaluated to determine the sentiment score. Individuals 24 can include any number of persons (i.e., Nth individuals) producing any number of numerical ratings 48 (i.e., Nth numerical ratings) and any number of textual descriptions 50 (Nth textual descriptions). Individuals 24 can include team leads 40 that manage team members 42, project leads 44 that are the managers of the entire project, or others 46 that are otherwise associated with/working on the project. As described in this disclosure, individuals 24 can be any persons, workstations, computers accessible by persons, or other hardware and/or software to which project inquiries 22 can be sent for individuals 24 to produce inquiry responses 26. Individuals 24 can include any number of people, including one or many dozens or hundreds. System 10 is configured to receive any number of inquiry responses 26 and determine multiple sentiment scores, and dashboard/user interface 34 can display as much information from as many individuals 24 as are associated with the project.

Inquiry responses 26 are produced by individuals 24 in response to project inquiries 22. Inquiry responses 26 can take any form for providing information from individuals 24 regarding the status of the project. In one example, each inquiry response 26 can include numerical rating 48, which (as described above) can be a rating by each individual 24 of 1 (poor), 2 (fair), and 3 (good) regarding the status of the project. Additionally, each inquiry response 26 can include textual description 50 that is an answer to the question: “how do you feel the project is going?”. Textual description 50 is intended to include at least a few sentences from individual 24 describing in his/her own words the status of the project. Inquiry responses 26 can include other information in other forms not expressly disclosed herein.

Project inquiries 22 can be sent out periodically to elicit inquiry responses 26 periodically to allow for the status of the project to be tracked over time. Sentiment tracker 20 can be configured to send out project inquiries 22, for example, to individuals 24 on the same day every week until the project is completed. Thus, inquiry responses 26 each week can be used to track the status of the project (as rated by individuals 24) over time. Additionally, one individual 24 can receive multiple project inquiries 22: one for each project that the individual 24 is working on (e.g., if individual 24 is working on five projects, that individual 24 may receive five project inquiries 22 and can produce five inquiry responses 25 (one for each project)). Project inquiries 22 having numerical rating 48 and textual description 50 can be used to determine the sentiment score, which is an aggregate of numerical rating 48 and a textual score derived/determined from textual description 50. The sentiment score can be determined by sentiment tracker 20 (such as by computer processor 28) or another component of system 10.

The sentiment score, as discussed in greater detail below, can be used by a managing principal as a quick and easy way to determine how individuals 24 believe the project is going. The sentiment score can be an indicator of a variety of situations or circumstances. The sentiment score can be used, for example, to understand the contribution of individual 24 to the project over time, a work team's assessment and/or state of mind regarding the project, how each or collectively the individuals 24 believe the project is going, and/or how connected or disconnected superiors (such as team leads 40 and project leads 44) are to the subjective assessment of the status of the project of other individuals 24 reporting to them (such as team members 42 and others 46). These and other benefits of determining and using the sentiment score can be realized by referring to FIG. 2.

FIG. 2 is a schematic showing example information of multiple projects each capable of having multiple component scores combined into an overall score. FIG. 2 also shows individual profiles that can include any information produced by/derived from individual inquiry responses across multiple projects.

System 10 with dashboard/user interface 34 can determine, display, and manipulate information (among other functions) regarding first project 60A, second project 60B, and third project 60C as well as individual profiles 62 for each individual 24. While only the features/information regarding first project 60A are shown and described with regards to FIG. 2, second project 60B and third project 60C can include similar features/information as first project 60A. First project 60A can include sentiment score 64, budget score 66, and schedule score 68 from which overall score 70 can be determined. Sentiment score 64 is shown in FIG. 2 as having an exemplary, nonlimiting variety of features either from which sentiment score 64 is determined or for which sentiment score 64 is used to make inferences, determine trends, and/or derive conclusions. The features of sentiment score 64 include lead score 72, team score 74, textual description 50, textual score 76, numerical rating 48, average sentiment score 78, keyword analysis 80, and/or sentiment analysis 82.

First project 60A can be any project, such as the development of a software program, on which at least one individual 24 is working to complete. In one example, first project 60A takes multiple weeks to complete and is being worked on by multiple individuals 24. First project 60A can have a monetary (or work-hours) budget for which completion of first project 60A is intended to stay below, as well as a schedule to which the development of first project 60A is intended to adhere. Budget score 66 can be determined from the budget for first project 60A and how much of the budget has already been allocated at any particular time (e.g., at the time budget score 66 is determined before first project 60A has been completed). Schedule score 68 can be determined from the schedule for first project 60A and how much time is left until first project 60A must be completed (e.g., at the time schedule score 68 is determined before first project 60A has been completed).

While the managing principal may find budget score 66 and schedule score 68 useful in assessing how first project 60A is proceeding, a managing principal of first project 60A may wish to have a subjective assessment by each individual 24 working on first project 60A as to how the project is proceeding. The managing principal may wish to get this assessment without the time-consuming process of speaking (either in person or virtually) to every individual 24 working on first project 60A. Thus, the managing principal will find system 10 useful in providing such information via sentiment score 64 and the associated features. Additionally, sentiment score 64 can be used early in the process of completing first project 60A before the collection/posting of budgetary or scheduling progressions. Thus, the managing principal may be able to see early on whether first project 60A is proceeding accordingly.

Sentiment score 64 can be used as one indicator/part of overall score 70, which can be determined from sentiment score 64, budget score 66, and/or schedule score 68. Overall score 70 can be a combination of and/or have coefficients to be a greater or lesser reflection of any of scores 64-68. For example, overall score 70 can be comprised of ⅓ each of sentiment score 64, budget score 66, and schedule score 68. In another example, where the budget is a greater concern/emphasis for first project 60A, overall score can be comprised of ½ budget score 66 and ¼ each of sentiment score 64 and schedule score 68. Other examples can include an overall score 70 that is comprised of other fractions of sentiment score 64, budget score 66, and schedule score 68.

Sentiment score 64 can be used by system 10 in a variety of ways. Along with being part of overall score 70, sentiment score 64 can trigger an adjustment/update to the budget, schedule, or other metrics/aspects of first project 60A. System can automatically adjust/update the budget, schedule, and other metrics. For example, if average sentiment score 78 for first project 60A is less than 2.0, system 10 can automatically adjust/update the budget and/or schedule to increase the amount of work-hours that can be dedicated to first project 60A. System 10 can also use sentiment score 64 of first project 60A to adjust the workload of the project manager in charge of first project 60A. For example, if average sentiment score 78 for first project 60A is less than 1.8, system 10 can automatically adjust the workload of the project manager to remove other projects so that the project manager can focus his/her time and effort on first project 60A to increase sentiment score 64 (and therefore increase the likelihood of success of first project 60A). Sentiment score 64 (and any variations of sentiment score 64) can be used to automatically change or update other aspects of system 10. Further, system 10 can, in response to a low sentiment score 64 (or a low average sentiment score 78) of first project 60A, can add more individuals 24 to work on first project 60A. Sentiment score 64 can trigger an alert that is provided to the managing principal or others associated with first project 60A to bring attention to a low (or high) sentiment score 64 that may be indicative of an issue with first project 60A.

Sentiment score 64 can be determined from numerical rating 48 and textual description 50, which are provided by each individual 24. Keyword analysis 80 and/or sentiment analysis 82 can be performed on textual description 50 to determine textual score 76. In one example, textual score 76 can be a value between −1 (being a maximum negative textual score 76) and 1 (being a maximum positive textual score 76).

Keyword analysis 80, which can be performed by computer processor 28 and/or other components of system 10, analyzes the words and/or phrases in textual description 50 to determine a value (e.g., textual score 76) of the positivity or negativity of the words and/or phrases. Keyword analysis 80 can also extract the key words from textual description 50 and display them via dashboard/user interface 34.

Sentiment analysis 82, which can be performed by computer processor 28 and/or other components of system 10, analyzes the words in textual description 50 and assigns each word as being positive, negative, or neutral. Sentiment analysis 82 then adds the number of positive, negative, and neutral words together to create textual score 76. Sentiment analysis 82 can be adjusted so that words are reassigned as being positive, negative, or neutral depending on the project, the individual producing textual description 50, the company completing the project, or other factors. For example, sentiment analysis 82 could originally view the word “optimized” as positive, but for first project 60A sentiment analysis 82 will assign the word “optimized” as negative. In another example, one individual 24 may use the word “opportunity” to express something negatively, so sentiment analysis 82 could be adjusted to categorize the work “opportunity” as negative when the word is used in a textual description 50 produced by that individual 24 (for all projects that individual 24 is working on). Textual score 76 can be determined using other strategies/methods aside from keyword analysis 80 and sentiment analysis 82, or textual score 76 can be a combination of the two analyses. Textual score 76 can be displayed and/or manipulated by/using dashboard/user interface 34 and/or other components of system 10. The results of keyword analysis 80 can be displayed to reflect the frequency and other relationship data of the keywords/phrases in textual description 50 (e.g., a keyword “cloud” with more frequently used words appearing in larger font than less frequently used words). Similarly, the results of sentiment analysis 82 can be displayed to show which words and/or phrases were assigned as positive, negative, or neutral.

Sentiment score 64 can be determined by aggregating textual score 76 and numerical rating 48, and sentiment score 64 can be determined from any combination of numerical rating 48 and textual score 76. As disclosed above, numerical rating 48 can be an integer that is 1, 2, or 3 and textual score 76 can be between −1 and 1, so sentiment score can range from 0 to 4. In one example, numerical rating 48 and textual score 76 are added together to form sentiment score 64. In this example, numerical rating 48 can be 2 and textual score 76 can be 0.34, and thus sentiment score 64 in this example is 2.34. In another example, textual score can be weighted. Using the same values as the previous example, textual score 76 can be multiplied by 2 before being added to numerical rating 48, and thus sentiment score 64 in this example is 2.64. Other examples can include numerical rating 48 and/or textual score 76 having coefficients that alter the base values before being added to one another to form sentiment score 64. For example, the numerical rating coefficient can be 0.8 (so numerical rating is multiplied by 0.8) and the textual score coefficient can be 1.15 (so textual score 76 is multiplied by 1.15). Such a configuration would have a sentiment score 64 that gives more weight to textual score 76 and less weight to numerical rating 48. These coefficients can be created and/or altered as deemed necessary by the managing principal or others to more accurately reflect the assessment of the status of first project 60A by individuals 24. Sentiment score 64 can be formulated using other strategies/methods not expressly disclosed herein.

Many variations, averages, and/or trends can be derived from sentiment scores 64 from individuals 24. Lead score 72 can be sentiment score 64 from one team lead 40 or can be the average sentiment score 64 from multiple team leads 40 (that are each in charge of at least one team working on first project 60A). Similarly, team score 74 can be sentiment score 64 from one team member 42, from all team members 42 on a particular team, or from all team members 42 on any team working on first project 60A. Lead scores 72 can be compared to corresponding team scores 74 to determine if team leads 40 have a similar view of the status of first project 60A as team members 42. Overall average sentiment score 78 can be determined by averaging the sentiment score determined for every individual 24 associated with first project 60A. Overall average sentiment score 78 can be a reflective of the overall assessment of first project 60A status. Other variations, averages, trends, etc. of sentiment score 64 not expressly disclosed herein can be determined, displayed, and/or manipulated as desired by a user (such as the managing principal of first project 60A) for indications as to the assessed status of first project 60A by individuals 24. Dashboard/user interface 34 can display individual sentiment scores, average sentiment scores, and any other information Moreover, overall score 70 can be determined using any variation, average, or combination of sentiment scores 64 from individuals 24. In one example, overall score 70 is determined from overall average sentiment score 78, budget score 66, and schedule score 68.

With project inquiries 22 being sent out periodically and inquiry responses 26 being received periodically as first project 60A progresses from beginning to completion, sentiment score 64 can be determined over time and plotted with regards to one or any combination of individuals 24 (e.g., the average sentiment score among all team members 42 can be plotted over time). Any trends can be determined by comparing a current sentiment score 64 to previous sentiment scores 64.

System 10, with dashboard/user interface 34, can display and/or manipulate information regarding each individual 24 (such as information in inquiry responses 26 from each individual 24) via individual profiles 62. Each individual profile 62 can display numerical ratings 48, textual descriptions 50, textual scores 76, and any other information (including trends over time and averages across one or multiple projects) for that individual 24. System 10, via computer processor 28 and/or dashboard/user interface 34, can determine and display any plots/graphs of sentiment score 64 over time for any one or combination of individuals 24.

The following are nonlimiting examples of system 10 and related processes of determining sentiment score 64 from inquiry responses 26 from individuals 24 regarding the status of a project (such as first project 60A, second project 60B, and third project 60C):

A process of determining a sentiment score from a response from at least one individual regarding a status of a project that includes receiving a first numerical rating regarding the status of the project from a first individual of the at least one individual, receiving a first textual description regarding the heath of the project from the first individual, determining a first textual score dependent upon the first textual description with the first textual score being a numerical representation of the first textual description, and aggregating the first numerical rating and the first textual score to determine a first sentiment score reflective of the status of the project by the first individual.

The process can further include that the first textual score is determined using a sentiment analysis in which words of the textual description are each assigned as being positive, negative, or neutral.

The process can further include that specific words associated with the project are reassigned as being positive, negative, or neutral.

The process can further include that specific words associated with the first individual are reassigned as being positive, negative, or neutral.

The process can further include that the first textual score is determined using a keyword analysis on the first textual description.

The process can further include that the first numerical rating is an integer that is 1, 2, or 3.

The process can further include that the first textual score is between −1 and 1.

The process can further include that the first numerical rating is an integer that is 1, 2, or 3; the first textual score is between −1 and 1; and the first sentiment score is between 0 and 4.

The process can further include the following steps: receiving Nth numerical ratings regarding the status of the project each corresponding to Nth individuals of the at least one individual, receiving Nth textual descriptions regarding the status of the project each corresponding to Nth individuals, determining Nth textual scores dependent upon each of the Nth textual descriptions with the Nth textual scores each being a numerical representation of the Nth textual descriptions, and aggregating each of the Nth numerical ratings and the Nth textual scores to determine Nth sentiment scores each reflective of the status of the project by each of the Nth individuals.

The process can further include determining an average sentiment score from the first sentiment score and the Nth sentiment scores.

The process can further include determining a budget score of the project dependent upon money allocated for the project and an amount of money spent on the project and determining a schedule score of the project dependent upon a deadline for the project and progress of the project.

The process can further include determining an overall project score of the project from the average sentiment score, the budget score, and the schedule score.

The process can further include displaying at least one of first sentiment score, the Nth sentiment scores, the average sentiment score, the budget score, and the schedule score via a user interface.

The process can further include comparing the first sentiment score to the average sentiment score.

The process can further include receiving a second numerical rating and a second textual description regarding the status of the project from the first individual with the second numerical rating and the second textual description being formulated by the first individual at a later time than the first numerical rating and the first textual description, determining a second textual score dependent upon the second textual description, aggregating the second numerical rating and the second textual score to determine a second sentiment score, and comparing the first sentiment score to the second sentiment score to determine a trend over time.

A system for determining a sentiment score from a response from at least one individual regarding a status of a project can include a communication device configured to send a project inquiry to the at least one individual and receive an inquiry response from the at least one individual with the inquiry response including at least one numerical rating and at least one textual description regarding the status of the project, storage media configured to store the project inquiry and the inquiry response, and a computer processor configured to determine at least one textual score dependent upon the at least one textual description and at least one sentiment score for each of the at least one individual dependent upon the at least one numerical rating and at least one textual score.

The system can further include a dashboard configured to display at least one of the numerical ratings, the textual descriptions, the textual scores, and the sentiment scores.

The system can further include that the computer processor performs a keyword analysis on the at least one textual description, and wherein the dashboard displays results of the keyword analysis.

The system can further include that at least one sentiment score includes more than one sentiment score from more than one individual, and the computer processor is configured to determine an average sentiment score from the more than one sentiment score.

The system can further include that the communication device periodically sends the project inquiry to the at least one individual and receives the inquiry response, and wherein the computer processor periodically determines the at least one sentiment score.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of determining a sentiment score from a response from at least one individual regarding a status of a project, the method comprising:
receiving a first numerical rating regarding the status of the project from a first individual of the at least one individual;
receiving a first textual description regarding the heath of the project from the first individual;
determining a first textual score dependent upon the first textual description, the first textual score being a numerical representation of the first textual description; and
aggregating the first numerical rating and the first textual score to determine a first sentiment score reflective of the status of the project by the first individual.

2. The method of claim 1, wherein the first textual score is determined using a sentiment analysis in which words of the textual description are each assigned as being positive, negative, or neutral.

3. The method of claim 2, wherein specific words associated with the project are reassigned as being positive, negative, or neutral.

4. The method of claim 2, wherein specific words associated with the first individual are reassigned as being positive, negative, or neutral.

5. The method of claim 1, wherein the first textual score is determined using a keyword analysis on the first textual description.

6. The method of claim 1, wherein the first numerical rating is an integer that is 1, 2, or 3.

7. The method of claim 1, wherein the first textual score is between −1 and 1.

8. The method of claim 1, wherein the first numerical rating is an integer that is 1, 2, or 3; the first textual score is between −1 and 1; and the first sentiment score is between 0 and 4.

9. The method of claim 1, further comprising:
receiving Nth numerical ratings regarding the status of the project each corresponding to Nth individuals of the at least one individual;
receiving Nth textual descriptions regarding the status of the project each corresponding to Nth individuals;
determining Nth textual scores dependent upon each of the Nth textual descriptions, the Nth textual scores each being a numerical representation of the Nth textual descriptions; and
aggregating each of the Nth numerical ratings and the Nth textual scores to determine Nth sentiment scores each reflective of the status of the project by each of the Nth individuals.

10. The method of claim 9, further comprising:
determining an average sentiment score from the first sentiment score and the Nth sentiment scores.

11. The method of claim 10, further comprising:
determining a budget score of the project dependent upon money allocated for the project and an amount of money spent on the project; and
determining a schedule score of the project dependent upon a deadline for the project and progress of the project.

12. The method of claim 11, further comprising:
determining an overall project score of the project from the average sentiment score, the budget score, and the schedule score.

13. The method of claim 12, further comprising:
displaying at least one of first sentiment score, the Nth sentiment scores, the average sentiment score, the budget score, and the schedule score via a user interface.

14. The method of claim 10, further comprising:
comparing the first sentiment score to the average sentiment score.

15. The method of claim 1, further comprising:
receiving a second numerical rating and a second textual description regarding the status of the project from the first individual, the second numerical rating and the second textual description being formulated by the first individual at a later time than the first numerical rating and the first textual description;
determining a second textual score dependent upon the second textual description;
aggregating the second numerical rating and the second textual score to determine a second sentiment score; and
comparing the first sentiment score to the second sentiment score to determine a trend over time.

16. A system for determining a sentiment score from a response from at least one individual regarding a status of a project, the system comprising:
a communication device configured to send a project inquiry to the at least one individual and receive an inquiry response from the at least one individual, the inquiry response including at least one numerical rating and at least one textual description regarding the status of the project;
storage media configured to store the project inquiry and the inquiry response; and
a computer processor configured to determine at least one textual score dependent upon the at least one textual description and at least one sentiment score for each of the at least one individual dependent upon the at least one numerical rating and at least one textual score.

17. The system of claim 16, further comprising:
a dashboard configured to display at least one of the at least one numerical rating, the at least one textual description, the at least one textual score, and the at least one sentiment score.

18. The system of claim 17, wherein the computer processor performs a keyword analysis on the at least one textual description, and wherein the dashboard displays results of the keyword analysis.

19. The system of claim 16, wherein at least one sentiment score includes more than one sentiment score from more than one individual, and the computer processor is configured to determine an average sentiment score from the more than one sentiment score.

20. The system of claim 16, wherein the communication device periodically sends the project inquiry to the at least one individual and receives the inquiry response, and wherein the computer processor periodically determines the at least one sentiment score.
